(19) United States
(12) Patent Application Publication
(10) Pub. No.: US 2025/0097212 A1
(43) Pub. Date: Mar. 20, 2025

(54) System and Method for Digital Identity Management

(71) Applicant: Cadena Platforms LLC, Manhattan Beach, CA (US)

(72) Inventors: Naveed Ihsanullah, North Andover, MA (US); Jason Bryant Weathersby, Inman, SC (US); Benjamin James Guidarelli, Cazenovia, NY (US)

(21) Appl. No.: 18/889,682

(22) Filed: Sep. 19, 2024

Related U.S. Application Data
(60) Provisional application No. 63/583,627, filed on Sep. 19, 2023.

(51) Int. Cl. H04L 9/40; H04L 61/4511

(52) U.S. Cl. CPC H04L 63/0823; H04L 61/4511; H04L 63/0442

(57) ABSTRACT

A system and method for managing digital identities that in an aspect provides an identity governance service that enables a Web2 architecture user identity to be verifiably linked with a Web3 architecture user identity, and records the verified and signed association of the two identities on a blockchain or similar data block record. Then, either of these digital identities may be employed to execute a digital event or transaction, and where action by an agent of the user may also be taken on behalf of the user in an authentic manner. Recovery of lost digital keys can be achieved in an aspect without reliance on centralized digital authorities.

### CROSS-REFERENCE TO RELATED APPLICATIONS

This application claims priority to U.S. Provisional Application No. 63/583,627, titled “Internet Identity Management System and Method,” filed on Sep. 19, 2023, which is hereby incorporated by reference.

### TECHNICAL FIELD

This application generally relates to systems and methods for managing and securing and authenticating digital identities (DID).

### BACKGROUND

In the ever-evolving landscape of the internet, identity management and verification have become critical challenges. As the digital world continues to expand, users interact with an increasing number of platforms, ranging from traditional Web2 services to the decentralized Web3 ecosystem built on blockchain technology. Each platform or framework may require separate and distinct user identities, leading to fragmented digital personas and cumbersome authentication processes for users.

Web2 platforms typically rely on centralized identity management systems, where user credentials and personal information are stored on servers maintained by service providers. However, this centralized approach poses significant privacy and security risks, as data breaches can expose sensitive user information to malicious actors. Web2 platforms are also typically owned by large corporations who ultimately wield all the power of the user, their data, and the user's ability to apply their identity to different purposes.

Web2 identities are typically username/password pairs set with a particular centralized service. The service can verify that a particular username and password are correct by verifying this information against data they possess. Once verified the centralized service then may enable the user to perform certain actions and may attest that those actions were performed by that user but only inside that system. Because the centralized system holds all the secure content and the attested data, a malicious user could compromise the centralized system and have it claim the user took action without any evidence to disprove the falsehood. In this system, the centralized service has sovereignty over the user's actions, authorizations and identity.

Web3 identities are typically Public and Secret Key pairs where the Public Key (PK), or simple variant thereof, acts as the public address/username of the user and the Secret Key, e.g., SKuser, can sign messages that are cryptographically verifiable as authorizations coming from the owner of that Public Key, e.g., PKuser. Only the owner/holder of the SKuser is able to sign content for a particular PKuser. This message signing can happen anywhere and is not constrained by a particular service, network or blockchain. In this system the holder of SK has sovereignty over their actions, authorizations and identity.

Creating Web3 entities by themselves is not a solution to this user sovereignty issue because the traditional Web cannot make use of Web3 public and secret keys. Additionally Web3 systems tend to be completely anonymous and subject to Sybil vulnerabilities. Anyone can create any number of Web3 identities easily and these can abuse resources and assert undue influence and control. Centralized systems attempt to limit certain digital attacks in which an attacker subverts a system's reputation service by creating a number of pseudonymous identities and using the identities to gain a false and disproportionate influence over the system (sometimes referred to as a Sybil attack). Centralized systems thus seek to avoid Sybil attacks using some constraint such as forcing accounts to be held by a real person using some limited resource like one per phone number or similar limitations.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

Embodiments of the present system and method overcome some or all of the challenges and limitations discussed above, and provide solutions and technologies that can achieve one or more of the following aspects.

In some aspects, the invention provides a system and method for managing digital identities across more than one digital architecture, e.g., across those sometimes referred to as “Web2” and “Web3” architectures, technologies, or methods. An aspect of the system and method provides an identity governance service that enables these different architectures, e.g., a Web2 architecture user identity to be verifiably linked with a, e.g., Web3 architecture user identity, and records the verified and signed association of the two identities on a blockchain or similar data block record. Then, either of these digital identities may be employed to execute a digital event or transaction, and where action by an agent of the user may also be taken on behalf of the user in an authentic manner.

An aspect is directed to a method for digital identity (ID) management, comprising, in a centralized digital identity service, establishing a first user identity by creating a user domain corresponding to said user, said user domain supporting the publishing of digital content to a publicly accessible location of said user domain; creating a first key pair for said user, the first key pair comprising a first public key and a corresponding first private key, wherein said first key pair is usable for cryptographically secure publication of domain data to said publicly accessible location of said user domain; obtaining a user certificate from a certificate authority, said user certificate issued by said certificate authority against said first key pair and said user domain; creating a second key pair for said user, the second key pair comprising a second public key and a corresponding second private key, wherein said second key pair corresponds to a second user ID and is usable for publishing data blocks onto a publicly accessible decentralized data block record base; publishing a first data block to said decentralized data block record base, the first data block signed using said first private key, the first data block comprising data confirming association of said first public key and said second public key and signed using said first private key; publishing a second data block to said decentralized data block record base, the second data block signed using said second private key, the second data block comprising data confirming association of said second public key and said first public key and signed using said second private key; verifiably and publicly linking said first user ID and said second user ID by way of said signed first and second data blocks; and executing a digital event requiring cryptographic authentication of said user, by providing either of said first user ID or said second user ID to verifiably execute said digital event.

An aspect is directed to a system for digital identity (ID) management, comprising an identity governance server having a plurality of hardware and software internal data management units including one or more of: a digital identity data store and a digital key management vault; a plurality of hardware and software external interfaces to respective external data processors, the external interfaces including one or more of a cloud identity service interface, placing said identity governance server in data communication with a user or user agent through a cloud identity service unit; a user identity interface, placing said identity governance server in data communication with a centralized digital identity service, and receiving from said centralized identity service a user domain corresponding to a first user ID; a certificate authority interface, placing said identity governance server in data communication with a certificate authority, and receiving certificates therefrom corresponding to a second user ID; a block record base interface placing said identity governance server in data communication with a decentralized data block record base, the block record base interface that generates and publishes a first data block confirming association of said first public key and said second public key and signed using said first private key, the block record base interface further generating and publishing a second data block confirming association of said second public key and said first public key and signed using said second private key; a digital key pair generator that creates a first pair of digital keys corresponding to said domain enabling cryptographic certification, and a second pair of keys enabling publication of data blocks onto said decentralized data block record base; and a digital signing unit that provides a digital signature and executes a digital event over a data connection with said identity management server, said digital signature enabled to execute said digital event using either said second user ID on behalf of said first user ID or using said first user ID on behalf of said second user ID.

An aspect is directed to method for linking digital identities, comprising generating a first digital identity corresponding to a user, said first digital identity corresponding to a first digital key pair, said first digital key pair comprising a first public key and a first private key; generating a second digital identity corresponding to said user, said second digital identity corresponding to a second digital key pair, said second digital key pair comprising a second public key and a second private key; publishing a first data block to a publicly accessible immutable ledger, said first data block encoding an association of said first and second digital identities, and encoding a first digital signature using said first private key; publishing a second data block to said publicly accessible immutable ledger, said second data block encoding an association of said second and first digital identities, and encoding a second digital signature using said second private key; and executing a digital event across multiple digital platforms, using said first and second data blocks for decentralized digital identity verification of said user, without reliance on a centralized identity service for executing said digital event.

And an aspect is directed to a method for digital key management in a digital identity management system, comprising receiving a signal indicating a compromise or loss of a digital key in a first digital key pair comprising a first public key and a first private key; using a domain name service (DNS) governance method to verify a digital domain ownership wherein said domain is linked to said first digital key pair; publishing an unlinking message to a publicly accessible immutable ledger to revoke an authorization of said lost cryptographic key; generating a second digital key pair comprising a second public key and a second private key; and linking said second key pair to said domain; publishing a linking message to said publicly accessible immutable ledger, allowing for digital key recovery without reliance on a centralized authority for said digital key recovery.

### BRIEF DESCRIPTION OF THE DRAWINGS

For a fuller understanding of the nature and advantages of the present invention, reference is made to the following detailed description of preferred embodiments and in connection with the accompanying drawings, in which:

FIG. 1 illustrates an exemplary identity governance service and server system and related data interfaces and data management units.

FIG. 2 illustrates an exemplary component of a system and method comprising an agent registration and adaptive verification.

FIG. 3 illustrates an exemplary component of a system and method comprising domain creation and TLS binding.

FIG. 4 illustrates an exemplary component of a system and method comprising auxiliary key creation.

FIG. 5 illustrates an exemplary component of a system and method comprising an key linking.

FIG. 6 illustrates an exemplary component of a system and method comprising content notarization.

FIG. 7 illustrates an exemplary component of a system and method comprising key loss mitigation.

FIG. 8 illustrates an exemplary process for provenancing on a secure blockchain framework.

FIG. 9 illustrates an exemplary process according to the present disclosure.

FIG. 10 illustrates an exemplary system and method for digital identity management and verifiable association according to one or more embodiments.

### DETAILED DESCRIPTION

As described, various current online frameworks require centrally managed identity services and cause multiple identity instances to be established for a given user, entity or person in each such framework, without a verifiable or true means of associating the user's identity in each such instance.

In the creative content space, rampant digital piracy and content plagiarism remain significant issues, undermining the rights of content creators and artists. With the rise of so-called generative artificial intelligence (AI) techniques, content authenticity and provenance are even more at risk. Establishing a robust and decentralized content authenticity framework becomes imperative to safeguard the intellectual property rights of digital creative work and ensure users can differentiate real authentic content from fraudulent unlicensed copycats.

The present disclosure uses terms such as “Web2” and “Web3” to generally describe different generations or infrastructure advancements in large scale global digital communication networks enabled by the Internet, namely embodied in what has become known as the World Wide Web (WWW) or simply the “Web”. Particularly, the term Web2 is commonly used to describe the support and use of the hypertext markup language (HTML) and related methods, where Web3 is commonly used to describe the added support and use of public key infrastructure (PKI) used for secure online transactions and the use of digital certificates and the use of cryptocurrency, blockchain methods, etc. The creation of web sites, HTML-based web pages and online domains is therefore part of the Web2 feature space, and such methods are centralized and provided or facilitated by a central agent, entity, organization or registrar that traditionally oversees domain name creation and management. The ownership of a domain in Web2 can be considered a form of Web2 digital identity of the person or entity that owns a given online domain through a respective central register. However, this Web2 technology lacks some useful rigorous ownership and authentication capabilities that are addressed by Web3 technology. The Web3 features support and enable creation of private-public key pairs and are decentralized in their implementation, and provide a user a secret (private) key for more rigorous ownership, authentication and control of online digital resources. Such features are used in technologies such as Ethereum and blockchain architectures under Web3 systems and methods. These Web3 methods are stronger and faster than prior (Web2) methods (e.g., HTTPS), and permit secure and reliable signing of digital contracts, secure transactions, and trustable exchanges involving electronic assets.

In one or more embodiments, the present system and method take aspects of both Web2 identity systems and Web3, and other new elements to enable a new technique for identity management that is as easy to use, Sybil resistant and as familiar as Web2 Identity while enabling Web3 user data and authorization sovereignty that can be used on any system, service, blockchain or digital content. A novel identity service is described, enabled and claimed herein, which uses cross-architectural aspects of Web2 and Web3 technologies. An aspect of the invention allows application of Web2 governance to Web3 identity structures as is described herein. Another aspect allows for an online party to legitimately and verifiably act on behalf of another online party as is described herein.

Therefore, in some aspects, the present disclosure is directed to a system and/or method that utilizes the Domain Name System (DNS) or similar centralized authorities as a federated intermediary, enabling users to connect, associate or link their identities between Web2 and non-centralized (decentralized) Web3 platforms, or other platforms or frameworks used in the present or future online universe. This connection establishes a seamless and efficient process for user identity and verification in a distributed network environment, while also ensuring content authenticity for all digital creative work generated by these users.

This disclosure is directed in some embodiments to a novel identity management system. The present Internet Identity Management System addresses the challenges of Identity Management, Identity Verification and Digital Content Authenticity on the Internet as understood by those skilled in the art.

In an aspect, the present system and method leverages domain name servers (DNS) as a federated intermediary and Public Key Encryption as a secure signing mechanism, enabling seamless user identity composition across both traditional Web2 services and the decentralized Web3 platforms. Those skilled in the art will appreciate that any or more such frameworks and platforms can benefit from and employ the present invention so as to be generalized to implementation across, one, two or more such platforms or frameworks.

In a specific exemplary instance regarding Web3, with its decentralized and trustless architecture, the platform has introduced blockchain-based identity systems that grant users greater control over their digital identities and, since it is based on public key encryption that is typically in the user's control, the user can apply their signing key whenever and however they wish. These Web3 identity systems, unfortunately, often operate independently, disconnected from Web2 platforms, and even other Web3 platforms, leading to a lack of interoperability and hindering the seamless user experience.

Moreover, the absence of a standardized and secure mechanism for verifying and connecting user identities across Web2 and Web3 platforms has limited the adoption of Web3 decentralized identity solutions to the vast majority of Internet users who remain solely on Web2 platforms. Consequently, users face authentication hurdles when navigating between these two distinct realms of the internet. As can be seen herein, the present system and method provide a means for overcoming such limitations and hurdles of prior architectures and techniques. Numerous benefits and applications of the invention are therefore made better or made possible for the first time.

To address these challenges and bridge the gap between the traditional Web2 and decentralized Web3 domains, the present invention introduces an innovative Internet Identity Management System. By leveraging the Domain Name System (DNS) as a federated intermediary, the invention enables seamless user identity verification across both Web2 and Web3 platforms. This approach not only ensures a secure and efficient user authentication process but also facilitates content authenticity for all digital creative works produced by users across the interconnected internet landscape.

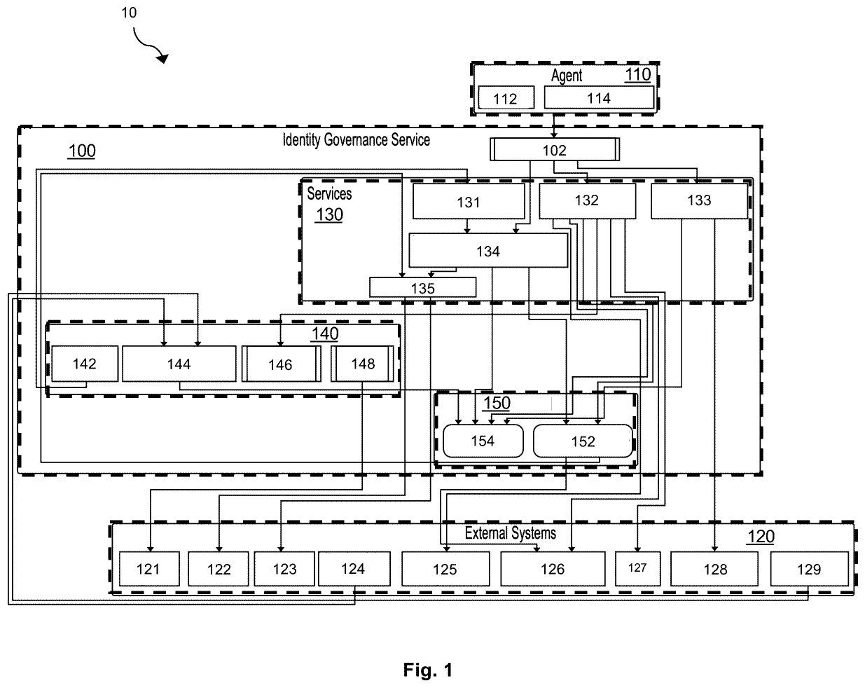

FIG. 1 illustrates an exemplary system, method and architecture 10 for supporting online or digital identity (ID) governance and an Identity Governance Service 100. The architecture 10 provides an overview of an exemplary and non-limiting Identity (ID) Governance Service 100 within an operational environment. This diagram illustrates conceptually how the Identity Governance Service 100 may comprise Services 130 and may interact with External systems 120, including so-called Web2 infrastructure like DNS Governance Servicer or providers 128, Web Domain Register 125, Web2 site 127, and certificate authorities 126, blockchain networks 122, 123, credential issuers 124 and credential verifiers 129, and Single Sign-On (SSO) providers 121 within the context of interfacial or provider coupling services 140. Of course, these units, modules and methods or processes can be arranged and grouped by those skilled in the art differently or as best suits a given implementation.

Cloud Identity Service 102 orchestrates these interactions, including with Internal services 150 handling identity management, key management, and the integration of immutable ledger (blockchain) technologies. Within the Identity Governance Service 100, core components such as the Key Management Vault 152 and Identity Data Store 154 ensure secure storage and management of cryptographic keys and identity-related data.

The Services 130 may include a digital content notarization unit or module and process 131 as discussed further below and optionally through a Notarization API 142. The Services may further support an Identity Management API 144 where data related to digital identities is to be exchanged with other components. A Web2 User Portal 146 is provided, as well as said SSO Provider interface 148. The Web2 Integration Service 132 and DNS Governance Service 133 enable seamless interaction with traditional web infrastructure, while the Immutable Ledger Integration Service 134 ensures that identity events and credentials are securely recorded on blockchain networks 135.

This diagram conveys an exemplary scope of the Identity Governance Service 100, emphasizing its ability to bridge Web2 and Web3 environments, provide secure and verifiable identities, and support both custodial and non-custodial key management. An Agent 110 is provided an identifier based on the hash of a purpose-specific namespace and a unique fingerprint. As the Agent 110 provides verifiable credentials or authority grants, the verifiability of the content they produce improves, including through an autonomous agent 114 serving an end user 112 in some examples. It is noted that the specific arrangement, grouping and connections among the foregoing exemplary parts of the system, method and architecture 10 are for the purpose of achieving the objectives of the system and method provided, and one skilled in the art can infer other particular arrangements of system components, groupings thereof, steps of a method, and groupings of such steps.

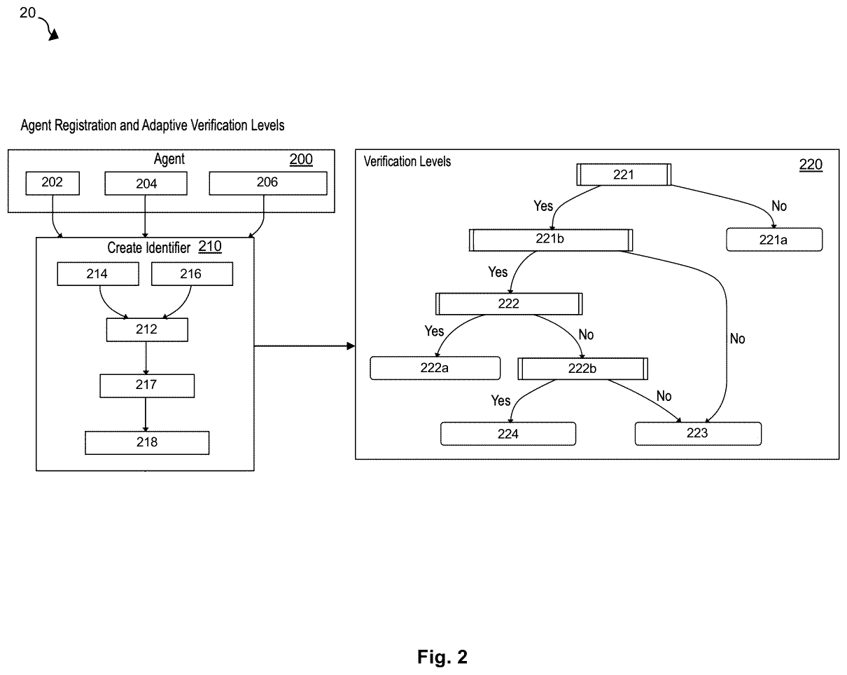

FIG. 2 illustrates an exemplary instance of agent registration and adaptive verification 20. An Agent 200, which may be anything that requires a verifiable ID such as a person, organization, or even a machine such as a digital automation, is provided an identifier 210 based on a hash 212 (e.g., Sha256 Hash) of a purpose-specific namespace 214 and a unique fingerprint 216 corresponding to a user or person 202, an entity or organization 204, or computer software program or asset 206 in that namespace (e.g., fingerprint: Bob's Phone domain: University). The hashing step or hash 212 provides an encoded output 217 (e.g., Base36 Encode) and a corresponding User Agent identifier 218, e.g., User Agent ID (UAID). As the Agent provides verifiable credentials or authority grants, the verifiability of the content they produce improves. In a non-limiting example, an Agent may be a colleague, partner, employee, attorney or attorney in fact, or may be a family member such as a parent acting on behalf of a minor or a person seeking or needing assistance.

The invention provides in some aspects for various verification levels 220. An account is created at 221, which may be a user or subscriber to or of a service such as an enterprise that runs and manages the present identity management services. The absence of a verified account at 221a does not permit or result in verification (process terminates). The confirmation of an account permits a verifiable credential at 221b. If a verifiable credential is presented at 221b then a delegate authority may be granted at 222. The availability of a delegate authority at 222 permits the system and method to provide a delegate verified content level of verification at 222a. Otherwise, the content can be signed directly (not as a delegate) at 222b. This direct content signing provides a principally verified content at 224. On the other hand, if a verifiable credential is not presented at 221b, then only a partial verification of content is permitted at 223.

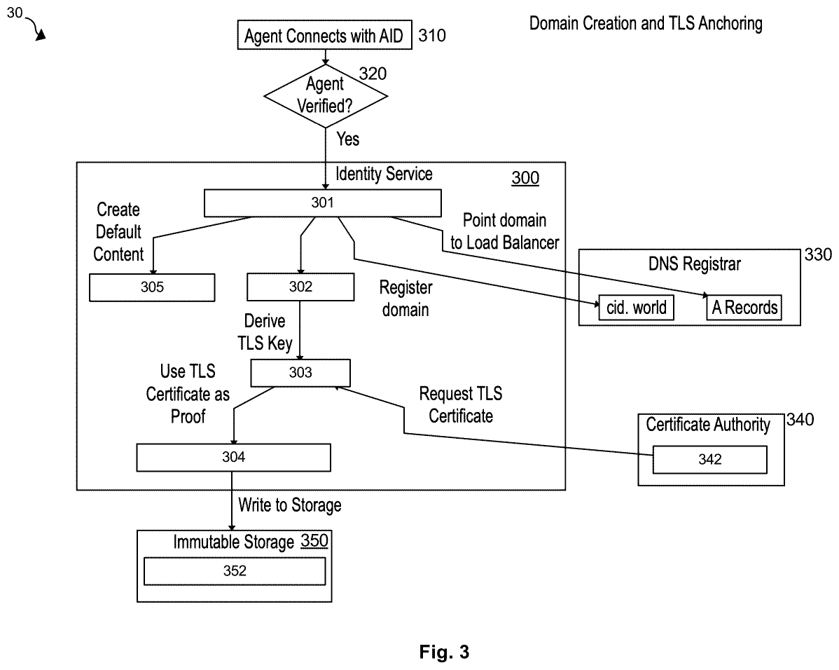

FIG. 3 illustrates an example of domain creation and transport layer security (TLS) binding subsystem and process 30 according to some aspects in the context of the present Identity Service 300. According to an aspect, an Agent is provided with Agent ID (AID), issued at the time of establishing an identity management service account, to connect at 310 and authenticate the Agent at 300. Upon initial verification at 320, the present Identity Service subsystem and process 300 is employed. The present Agent is provided with one or more of (1) a Domain name based on their ID, (2) a TLS Key, (3) a TLS Certificate at 301, (4) a Basic Homepage or Dashboard 305, served over HTTPS with their TLS Certificate, and (5) a W3C Decentralized Identifier (DID) containing the details of the Certificate. At 302 a TLS Key Generator of the system and method generates a TLS Key, which is provided to a Key Manager at 303. A Certificate Authority 340 provides a TLS Certificate 342 upon request. The TLS Key and Certificate serve to bind the identity of the Agent to the logical location of the acquired domain where DNS Registrar 330 and the Certificate Authority 340 have oversight. The change to the DID document is written to Immutable Storage 350 in the form of a log entry (e.g., a Verifiable Credential at 304) that is verifiable against the TLS Key. The Immutable Storage may comprise a DID document change log 352. As a general observation, DNS Registrar 330 and Certificate Authority 340 may be considered as Web2 technologies, while Immutable Storage 350 may be considered as a Web3 technology (e.g., a blockchain) for the present example.

The Identity Service 300 acts on behalf of the Agent and registers domains with a Web2 centralized registration authority (e.g., DNS registrar) on behalf of the Agent. Then, a TLS Key is generated as described and a TLS Certificate is acquired against said TLS Key and domain from the authority. This activity is logged by publishing appropriate information data records to the immutable blockchain or similar storage.

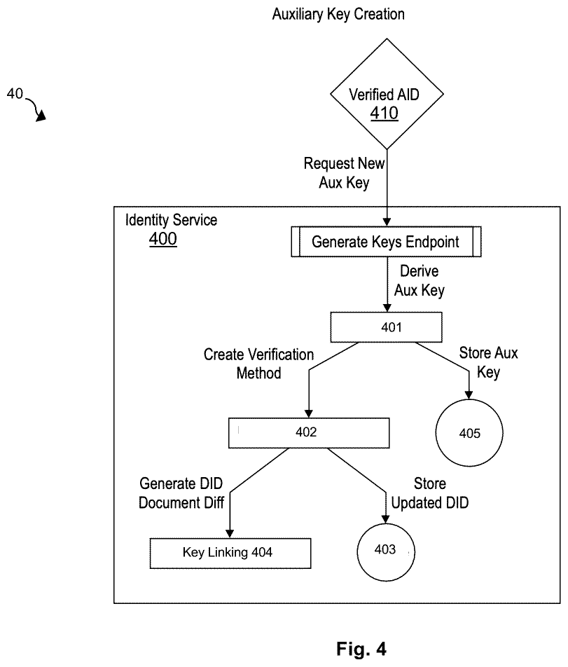

FIG. 4 illustrates an exemplary component of a system and method 40 for creating auxiliary keys in an Identity Service 400 according to an aspect. A Verified Agent or AID 410 may request additional, new or Auxiliary Keys 401 to be created and custodied for them. A Key Endpoint is a Web application program interface (API) that an Agent may contact to register or create additional or auxiliary keys connected to their ID (AID). The Auxiliary keys may be used by the Agent 410 to authorize or authenticate content in different arenas. The Auxiliary keys 401 are associated with the rooted TLS Key and Domain by providing some proof (signatures) that the keys should be associated using a verification method. This may be in the form of a DID document update 402, which in a non-limiting example may be formatted as a difference (“Diff”) and signed by both the original TLS Key and the Aux Key. Said “Diff” may be written to an immutable storage 403 to form a chain of updates, allowing historical reconstruction of the DID document at any time. Key Linking 404 is then provided as discussed in the following examples. The updated DID is stored in internal storage 403. Any auxiliary keys (Aux Keys) are stored in Key Vault 405.

As mentioned herein, the foregoing and all exemplary embodiments of the invention and aspects of the present system and method are provided by way of explanation and not limitation. Specific implementations are possible and can be appreciated by those skilled in the art similar, equivalent or in other ways as those shown in these particular examples. All such instances are comprehended by this disclosure and the appended claims.

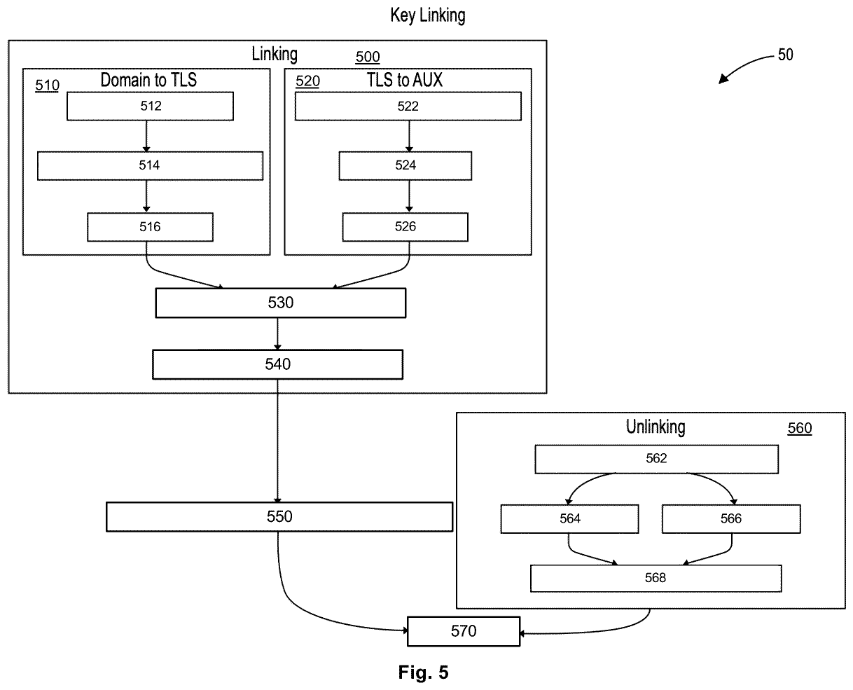

FIG. 5 illustrates an exemplary component of a system and method 50 for linking keys according to the present disclosure and in the context of a Key Link 500 of the present identity service architecture. As stated, a given user may have multiple issued key sets, including Agent and/or Auxiliary key sets. An aspect provides that an Agent's TLS Key and/or Aux Key can be used. The aspect of linking comprehends a Domain to TLS linking 510, as well as a TLS to Aux Key linking 520 in some aspects. An agent may wish to “Link” their keys with one another so that the proof (signature) generated by the key is taken as authentication or authorization of the agent, regardless of which key is used.

Domain to TLS key linking 510 binds the user identity to DNS, the proof provided to link the TLS Key to the Domain is the TLS Certificate, signed by a Certificate Authority. In the example, logic and steps may include: procuring a TLS Certificate at 512, creating a verifiable message regarding the link at 514, and signing the event using the TLS Key at 516.

The TLS to Auxiliary key linking 520 provides a way to link the primary/bound identity to any cryptographic key, including blockchain keys, other TLS Keys, or encryption keys. In an example, logic and steps may include: creating a verifiable message regarding the link at 522, signing the event using the TLS Key at 524, and Signing the event using the Aux Key at 526.

The above linking processes 510, 520 in the linking process 500 are followed by sending a message regarding the linking act(s) to immutable storage at 530 such as by creating and publishing data blocks to a blockchain or a data block store. The linking may be made valid for a limited time period, duration, and may expire or be void thereafter, indicated at 540. This may be separately published to the blockchain. Step 550 illustrates expiration of the scheduled or permitted linking time duration at 550, at which time the linking becomes invalid as indicated at 570.

Therefore, the system and method may support undoing the linking, or “unlinking” 560. Like linking, unlinking may be done by writing a record or data block to the blockchain specifying the details of the keys to be unlinked and signed by at least one of the keys associated with the identity. Unlinking can be done by writing a superseding record or data block to overwrite the current state at 562. The unlinking message block may be signed with a TLS key at 564 and/or an Aux Key at 566, written to the blockchain at 568. Unlinking may also happen implicitly if a refreshed link message is not written prior to link expiration.

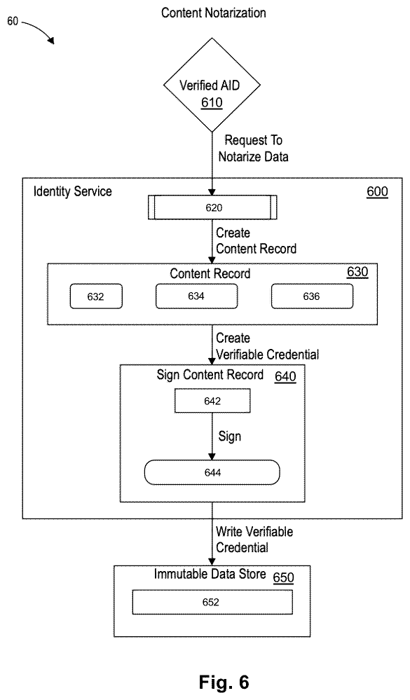

FIG. 6 illustrates an exemplary component of a system and method 60 for content notarization according to some aspects. An Agent may produce some content that they need to verify as authentic and untampered with by providing cryptographic proof that the content was authorized as well as having the proof written to an immutable datastore, providing proof of a timestamp for the content. An Agent as described herein provides a request to an Identity Service 600 to notarize data using the Agent's ID (AID) at 610. Through a Notarize Endpoint 620, the content is summarized into a Content Record with relevant fields and signed to produce cryptographically verifiable evidence of authenticity. After signing, the Verifiable Content Record 630 may be written to an immutable datastore which can be referred to later, in some examples including a Hash 632, a Timestamp 634, and a Source URL 636. The content of such a record as a verifiable credential is presented in a Signed Content Record 640 by fetching a key (Fetch key at 642), signed to create the Verifiable Credential 644. Writing or publishing the Verifiable Credential 644 to an immutable data store 650 is done as explained to a data block record base (e.g., a blockchain) as a Verifiable Content Record 652.

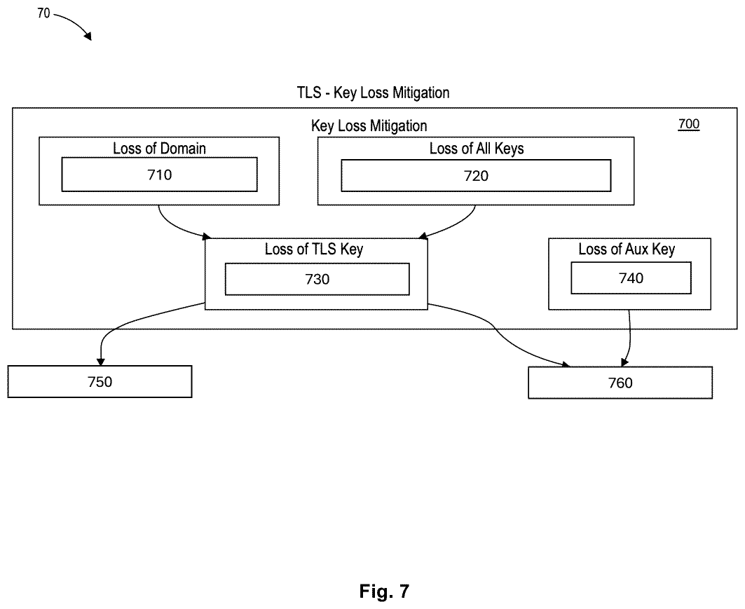

FIG. 7 illustrates an exemplary component of a system and method 70 for key loss mitigation. The loss of cryptographic keys in some aspects is not catastrophic, but rather, can be mitigated by a Key Loss Mitigation unit and method 700 of the invention in the present context. In the case that all keys are lost, e.g., at 720, one can first regain control of the Domain through the registrar. In the case the Domain is lost, e.g. at 710, one can follow the UDRP protocol to regain control of said Domain. In both of the above scenarios, and in the case the TLS key is lost, e.g., at 730 one can generate a new TLS key, then procure a TLS Certificate and proceed with linking or unlinking as described earlier. In the case that the Aux key is lost, e.g., at 740, one can use the TLS key to unlink the lost Aux key. The loss of the TLS Key or Aux Key can be addressed in accordance with Unlinking of an old key at 760 as described before, while the loss of a new key can be addressed in accordance with Unlinking of the new key at 750.

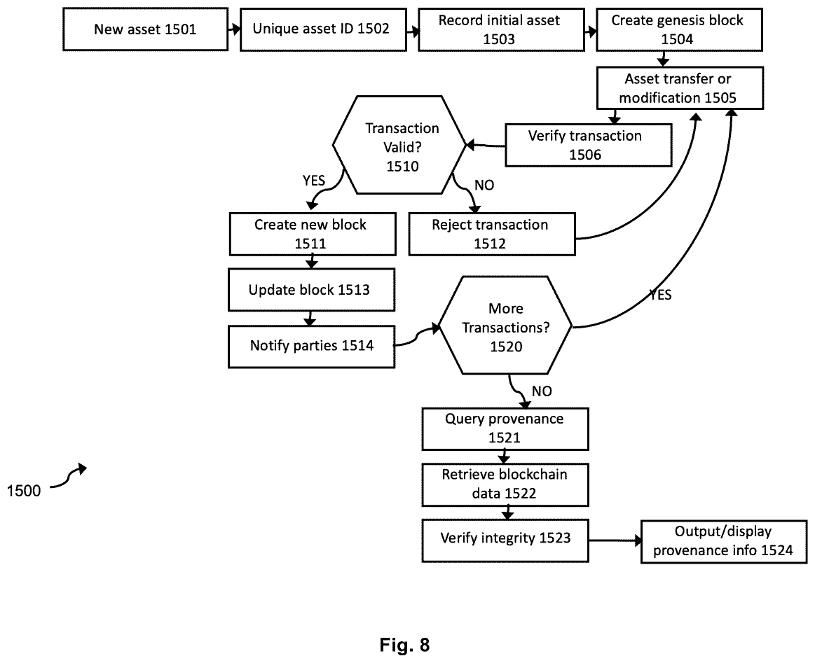

FIG. 8 illustrates an exemplary process and system parts 1500 for provenancing on a secure blockchain framework as employed by the present system and method in some aspects. A new asset is created at 1501. Generally, the asset may be any digital asset, information, encoded signal or message. The asset is allocated a unique identifier ID at 1502. The asset is further recorded as an initial asset data at 1503. This is performed by creating a genesis block in the blockchain at 1504. Asset transfers or modifications are recorded at 1505. Any transactions related to the asset are noted and recorded at 1506. The system and method determine whether a transaction in the asset is a valid one at 1510. If valid, a new block is created in the blockchain at 1511. If not valid, the transaction is rejected at 1512 and other actions taken or reported. The blockchain is updated at 1513. Interested parties are notified at 1514.

If further transactions are required or occur at 1520, the process returns to 1505. If no further transactions occur then the provenance is queried at 1521. The blockchain data is retrieved for this operation at 1522, and its integrity is verified at 1523. Finally, the system and method may output or provide or display the results of the provenancing at 1524.

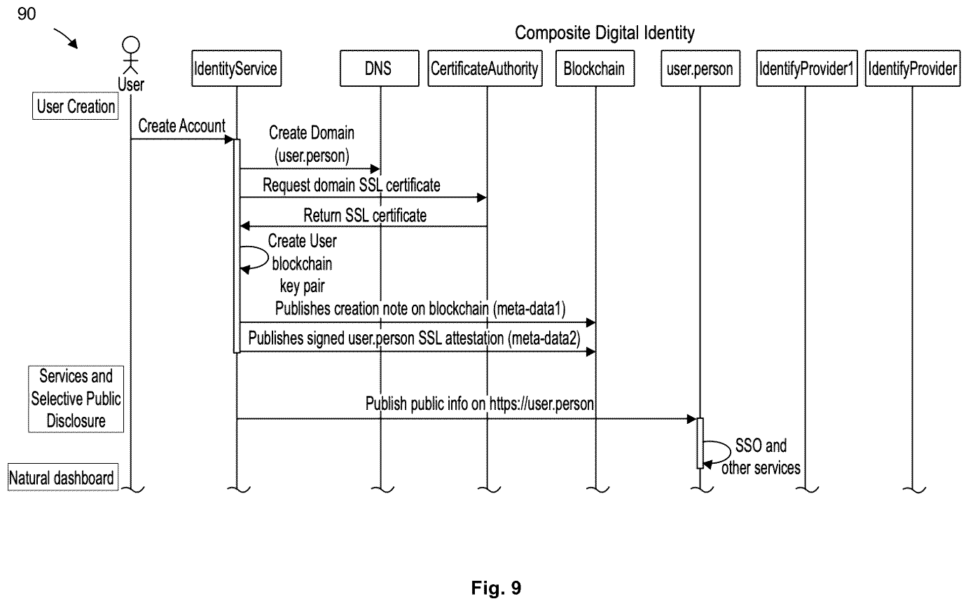

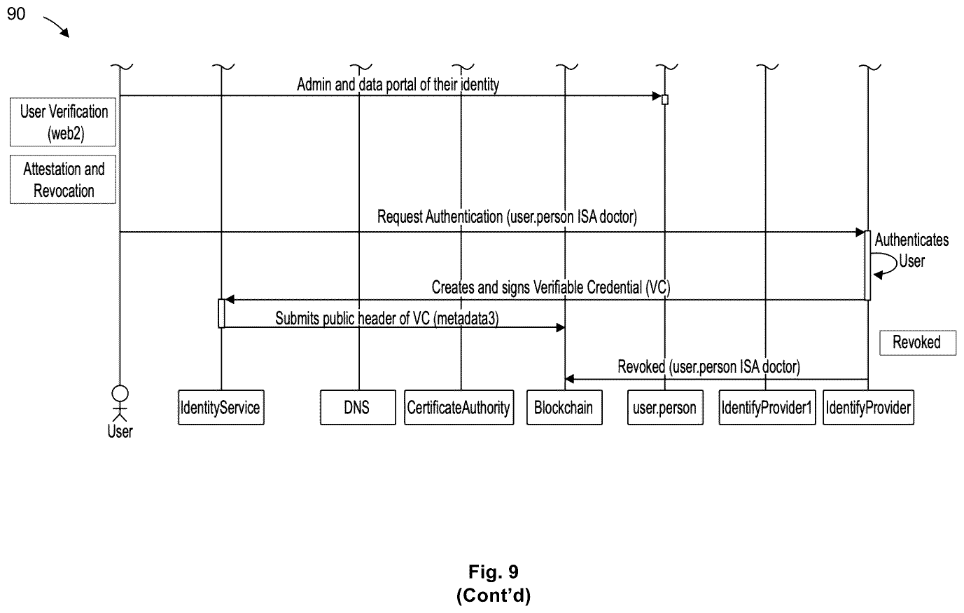

FIG. 9 is presented on two drawing sheets merely for the sake of clarity to avoid over-crowding of the drawing sheets, where the latter sheet is considered contiguous with the former sheet as shown. The figure illustrates an exemplary process 90 showing some entities or parties or systems involved in a method of carrying out a non-limiting instance of the invention, including some of the data and information exchanged therebetween.

It is to be understood that the present exemplary illustrative aspects and embodiments are not provided by way of exhaustion or limitation. Rather, these illustrative examples include explanatory and preferred aspects intended to show those skilled in the art how these aspects can be carried out in one or more instances. Those skilled in the art will therefore appreciate other specific implementations of the systems and methods provided in the examples.

In the example of FIG. 9, we see an architecture and process 90 for a method and system for digital identity management. A user (User1) registers a single user, fully qualified domain, e.g., user1.person. This can be carried out using Web2 techniques and methods and architectures in one example, e.g., with the assistance of a domain issuance centralized authority or DNS. A user thus can sign up for the present service and, e.g., a website or site is created for the user. This site and the pages and information on it may thus support publishing of digital content (text, code, images, electronic files, etc.) and can be administered using Web2 methods and may comprise a centralized digital identity service that establishes a first user identity using said domains. The user's public key is thus available of the user's site and may be publicly accessed at accessible locations on the site by others (humans, machines, software browsers, etc.) as needed and according to applicable protocols.

User1 obtains a user certificate, e.g., in a non-limiting example a TLS certificate, from a trusted Certificate Authority for user1.person, e.g., TLSuser1. A PKI pair (SSL certificate) is created for the site, for example as a first key pair comprising a first public key and a corresponding first private key. The site being secure can appear on a web browser with the customary “lock symbol” beside the URL thereof indicating its certification.

TLS, like blockchain, makes uses of public key cryptography so a TLS certificate is composed of a public and secret key component, e.g., PKTLSuser1 and SKTLSuser1.

User1 creates a public/secret key pair for a blockchain account, e.g., PKEthereum with the corresponding SKEthereum. Therefore, this aspect may be carried out in and using Web3 architectures and methods. Note that throughout this disclosure, the reference to a “blockchain” or a decentralized data block record base is to be understood generally to encompass any immutable public record structure onto which data blocks as described may be published or written for the purpose of verification and other assured documentation of said records and blocks. Typically such data blocks include a time/date stamp indication and may be signed as appreciated by those skilled in the art. The second set of keys can comprise a second key pair comprising a second public key and a second private key. Note that the user or owner can establish, remove or transport (move) his or her keys to or from the service of the present system and method as the user sees appropriate.

User1 composes a message called messagelinked stating “PKEthereum and PKTLSuser1 are linked”. One or more blockchains can be targeted and used. This linking is described in detail above and comprises provable verified indication that the owner of a first digital identity and the owner of a second digital identity have mutually authorized, approved and verified their ability to act on behalf of one another, sometimes within a scope such as a time scope or nature of an action delegation and agency.

User1 signs messagelinked with SKEthereum and SKTLSuser1. The corresponding public keys can be used to verify that this message is legitimate. In an aspect, the DNS server acts as a trusted global server that acts to verify that the user.person is actually and verifiably associated with the proper user and establishes ownership.

Accordingly, in one aspect, the present system and method can use DNS as a trusted intermediary for PKI transactions over one or more blockchains.

User1 submits messagelinked to any number of well known locations such as a global blockchain. Since this signed message will not pass cryptographic verification if fraudulent, its location only has to ensure availability, not security.

User1 can now sign any content, transaction or message with SKEthereum and the world can verify that those signatures are valid and represent user1.person. The user's webpage or site can be used as a dashboard to control the user's identity portfolio and act as a natural landing page. The user/owner can here see and modify what he or she is signing, digital agreements, contracts and asset transactions. The user/owner can also make or cancel/revoke authorizations with respect to his or her identity using such a dashboard. In an example, a powerful and flexible power of attorney is an application of such techniques.

Additionally User1 can declare structured facts about themselves at http://user1.person and Web2 services can consume those facts safely without fear of an adversary creating fraudulent information.

Whereas conventional techniques do not recognize TLS as using public-private key infrastructure, an aspect of the present technique comprises using TLS certificates securing DNS that can expire and may even be revoked. The message linked will contain life time information inherited from the TLS expiration or a more restrictive policy that is applied. Blockchain addresses may be compromised or the secret keys may be lost. The above communication protocol supports any side of joined identity to declare they opt out with a new signed message indicating the conclusion. The history of connection and termination along with their timestamps will be a permanent record on the blockchain.

In an example, several identities can be linked or verified to be associated with a user or base identity. Therefore, a first identity's private key can be used to sign the public key of a second identity where the first and second identities are verified as belonging to a same verifiable base entity and identity. In the present system and method, each of the first and second identities may be established and used in a different online or internet framework or platform. For example, a first identity may be used in the context of Web2 (e.g., a browser) and a second associated identity may be used in the context of Web 3, and so on, not limited to these examples. This can enable a powerful functionality not previously possible or securely verifiable, which is the notion of one entity, user or identity acting as a digital proxy for another one or plurality of such entities, users or identities.

Proxies enabled by the present system and method can be useful in many applications. Where a real user having a real identity is constrained to the physical universe, his or her online or digital identities have to conform to the particular digital implementations of the online or digital universes the user uses. Therefore, in each such online platform or sphere of activity, the user needs to have corresponding digital proxies to carry out transactions or legally-significant actions. DNS is useful in the above context as it is generally employed across some, most or all existing digital platforms, frameworks or media in which a user makes such actions and decisions.

The present technique may implement a method of pinning that associates and cross-identifies a user with more than one instance of his or her identity in respective digital spaces.

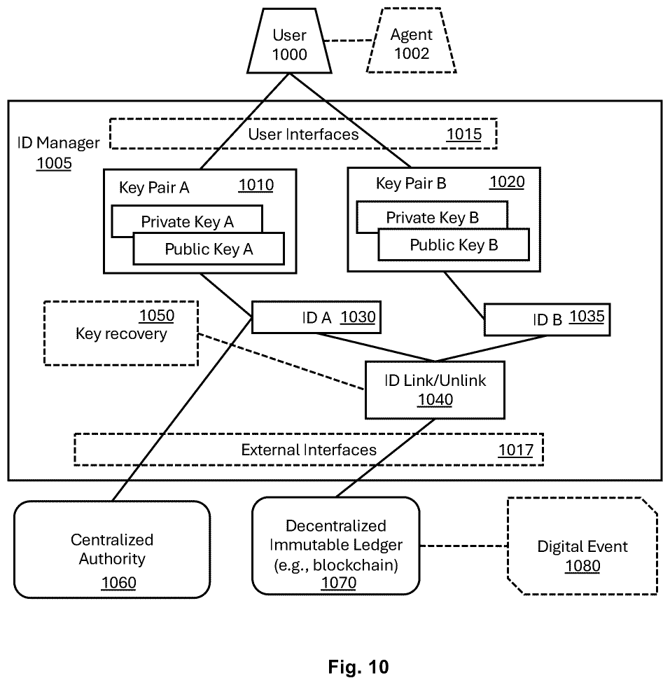

FIG. 10 illustrates an exemplary arrangement of a system and/or method for digital identity management 1005 operable on behalf of a user 1000 and/or user agent 1002 and capable of associating a plurality of digital identities for carrying out secure authenticated and verifiable transactions or digital events across more than one digital architecture as described herein.

The ID Manager may comprise an ID management server, implemented as one or more coupled units including suitable hardware circuitry and/or machine readable program instructions, operating on associated data using data communication interfaces and data storage units. A User Interface 1015 couples the ID Manager 1005 to said User 1000 and/or Agent 1002. A digital cryptographic key generator(s) is employed to create a first Key Pair (A) 1010 including a first Private Key A and a first Public Key A, to create a first Digital ID A 1030 using a Centralized Authority (e.g., but not limited to a DNS service) 1060. A second digital cryptographic Key Pair (B) 1020 is created as well, including a second Public Key B and a second Private Key B, which are associated with a second Digital ID B 1035.

A Digital Key Linker (and sometimes Unlinker, which may be the same or a separate module) 1040 are used to associate said first and second digital IDs 1030, 1035. In an optional aspect, a Key Recovery unit or module 1050 is provided as described herein to recover compromised or lost keys.

Verifiable records, e.g., data blocks containing necessary information for verifiably confirming the association and agreement by the owner(s) of ID A 1030 and ID B 1035 are published, recorded or written to a Decentralized Immutable Ledger 1070, which may be but not necessarily limited to a blockchain. This Ledger 1070 is publicly accessible to entities or persons needing to confirm the association, scope of association, or revocation of association of the first and second IDs 1030, 1035. The Manager 1005 may conduct data exchanges with said authorities or ledgers or other systems by way of External Interfaces 1017. The published data blocks on the Immutable Ledger 1070 may include date stamps, payload or informational data regarding the substance of the association, linking or scope of authorization, as well as verifiable digital signatures using said first Private Key A and said second Private Key B on behalf of the first and second Digital IDs, respectively.

Once the system and method have provided for verifiable and public linking or association of said first and second digital IDs 1030, 1035, the system and method can enable a variety of digital transactions, events, conveyances, content authoring, and so on, 1080, whereby one of the linked (authorized) IDs can act in a verifiable and authentic manner on behalf of the other. This is especially useful in the case of cross-architectural digital events or transactions requiring authenticated certification over a plurality of digital architectures (e.g., Web2, Web3, other) where a digital method can be applied by a competent digital ID of the user or agent in the relevant digital universe of the transaction or event.

Merely by way of illustration, those skilled in the art may benefit from the following exemplary instance of pseudo-logic which may be employed and applied as appropriate to a given implementation:

```
  <!--- This is can be viewed in VS Code with mermaid plugin OR by copying -->
  <!--- ‘‘‘mermaid block into editor at https://mermaid.live/ -->
‘‘‘mermaid
---
title: Composite Digital Identity
---
sequenceDiagram
    actor User
    participant IdentityService
    participant DNS
    participant CertificateAuthority
    participant Blockchain
    participant user.person
    participant IdentityProvider1
    Note left of User: User Creation
    User->>IdentityService: Create Account
    activate IdentityService
    IdentityService->>DNS: Create Domain (user.person)
    IdentityService->>CertificateAuthority: Request domain SSL certificate
    CertificateAuthority->>IdentityService: Return SSL certificate
    IdentityService->>IdentityService: Create User blockchain key pair
    IdentityService->>Blockchain: Publishes creation note on blockchain (meta-data1)
    IdentityService->>Blockchain: Publishes signed user.person SSL attestation (meta-
data2)
    deactivate IdentityService
    Note left of User: Services and Selective Public Disclosure
    IdentityService->>user.person: Publish public info on https://user.person
    activate user.person
    user.person->>user.person: SSO and other services
    deactivate user.person
    Note left of User: Natural dashboard
    User->>user.person: Admin and data portal of their identity
    activate user.person
    deactivate user.person
    Note left of User: User Verification (web2)
    Note left of User: Attestation and Revocation
    User->>IdentityProvider: Request Authentication (user.person ISA doctor)
    activate IdentityProvider
    IdentityProvider->>IdentityProvider: Authenticates User
    IdentityProvider->>IdentityService: Creates and signs Verifiable Credential (VC)
    deactivate IdentityProvider
    activate IdentityService
    IdentityService->>Blockchain: Submits public header of VC (metadata3)
    deactivate IdentityService
    Note right of IdentityProvider: Revoked
    IdentityProvider ->> Blockchain: Revoked (user.person ISA doctor)
‘‘‘
```

Being at least partly machine-implemented or assisted, the present systems and methods preferably include and operate using specialized computing hardware, which can vary significantly from one implementation to another depending on the needs of a given application or user. The same can be said for the software, data, data storage means, methods and processes associated with the foregoing architecture. In some aspects, the system and method includes high performance servers such as a distributed cluster of high performance computing machines that handle the computational demands of the system and method. These may be equipped with server-grade central processing units (CPUs) having high core counts for parallel processing capabilities if necessary. Also, general processing units (GPUs) and clusters of GPUs may be used to accelerate machine learning and AI operations. These may use GPU virtualization techniques to efficiently allocate GPU resources across different tasks.

A distributed data storage infrastructure is also an aspect of some embodiments. These may implement a combination of high-speed SSD storage for frequently accessed data and large-capacity HDD storage for archival data storage purposes. In some aspects, distributed file systems (e.g., Hadoop distributed file systems) may be employed for scalable and fault-tolerant data storage.

As far as the computer programs, machine-readable instructions and software facets of the system and method, they may be implemented in a variety of suitable programming environments, languages and means. Any such implementation is comprehended by this disclosure and invention and may be chosen by those skilled in the art to meet their particular scenario and needs. A software stack in a non-limiting example may include one or more of: an operating system, e.g., Linux-based or other system optimized for high-performance computing and real-time operations; containerized and orchestrated software implementing, e.g., Docker technology for containerization of system components, or using Kubernetes for orchestrating and managing the deployment of containers across a computing cluster; distributed computing frameworks, e.g., using Apache Spark or similar technologies for large-scale processing and machine learning tasks, and Apache Flink or similar technologies for real-time stream processing; machine learning libraries, e.g., using TensorFlow and PyTorch for deep learning model development and deployment, or scikit-learn for traditional machine learning methods; database management employing a combination of relational (e.g., PostgreSQL) or NoSQL (e.g., Cassandra, MongoDB) databases to handle different data types and access patterns, or using Redis for in-memory caching of frequently accessed data; message queueing systems, e.g., Apache Kafka for high-throughput, fault-tolerant message queueing between system components; and API management using a suitable API gateway, e.g., Kong, Apigee, to manage, secure and monitor API access to the system.

The data communication network and communication of information encoded in digital signals over communication links and pathways of said network may comprise proprietary or standardized techniques, or combinations thereof. For example, the system and method's data exchange and transport over such networks may comprise one or more of: content delivery networks (CDN) integrated to ensure fast delivery of ad content to users across geographical locations; real-time bidding (RTB) protocols, e.g., implementing Open RTB protocols for real-time bidding interactions with ad exchanges; data transfer protocols, e.g., using gRPC for efficient, low-latency communication between internal system components, or implementing GraphQL for flexible, efficient data querying from client applications; and security protocols, e.g., using TLS/SSL encryption for data transmission, or implementing OAuth and JWT or similar means for secure authentication and authorization. It should be understood, as with the present disclosure of preferred or exemplary software and hardware examples, that these are merely provided for the sake of better understanding and description of some aspects of the exemplary embodiments. Those skilled in the art will appreciate that equivalent or derivative or future versions or similar means may be substituted for any needed functionality provided by the exemplary illustrations.

As an illustration of the breadth and flexibility of applications benefiting from the present system and method we may consider a few examples to aid those skilled in the art to appreciate the uses of the invention and enable them to apply the invention to other problems in their field of use.

Consider a scalable blockchain-based provenance tracking process for multi-channel ad campaigns. For example, a consumer electronics brand intends to launch a new product (e.g., a smartphone) with a multi-channel digital advertising campaign across various publishers, social media platforms, and ad networks. Here, the system and method may create a unique blockchain entry (genesis block) for each ad creative in the campaign, including metadata such as brand information, campaign ID, and initial targeting parameters. Each placement, impression, click, and conversion related to each ad is recorded as a new block in the blockchain, creating an immutable history of the ad's performance across all channels. The content generation engine creates dynamic, context-aware variations of ad content based on real-time performance data and blockchain-recorded user interactions. The matching engine optimizes ad placements across various platforms, considering factors such as historical performance data stored in the blockchain, current market trends, and target audience behavior. The analytics engine further provides a comprehensive view of the campaign's performance across all channels, leveraging the blockchain's immutable record to ensure data accuracy and prevent discrepancies between different platforms' reporting. Smart contracts automatically execute payments to publishers and ad networks based on verifiable performance data, with all transactions recorded in the blockchain for transparency. The system and method provides a secure interface where the brand, agencies, and publishers can access the complete, tamper-proof history of the campaign's performance, enhancing trust and accountability in the advertising ecosystem. Machine learning models analyze the blockchain-recorded provenance data to identify the most effective customer journey paths, optimizing future ad placements and budget allocations. The system and method's fraud detection engine, module or process continuously monitors for suspicious acts or pattern in ad interactions, using the blockchain's historical data to establish baseline behaviors and quickly identify anomalies that may indicate bot activity or click fraud. The system and method's cross-platform attribution engine, module or process leverages the blockchain's comprehensive record to accurately track an credit user interactions across different channels and devices, providing a true multi-touch attribution model.

These use cases illustrate how the present system and method use blockchain based provenance tracking, combined with adaptive content generation (for ad and/or publisher content) and cross-platform attribution capabilities. These abilities are novel and useful to enhance transparency, effectiveness and efficiency of digital promotion efforts and placement of digital ad content in corresponding digital publisher content spaces. By providing immutable records of all ad interactions, the invention can address existing challenges in digital advertising. These include but are not limited to data discrepancies, ad fraud, and accurate attribution. This can, inter alia, improve overall campaign performance and return on investment for advertisers, and foster a more trusted and accountable ad ecosystem for all stakeholders.

This disclosure should not be considered limited to the particular embodiments described above. Various modifications, equivalent processes, as well as numerous structures to which the present technology may be applicable, will be readily apparent to those skilled in the art to which the technology is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in field programmable gate arrays (FPGAs) or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a personal digital assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, an intelligent network, or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of the present application need not reside on a single computer or processor, but may be distributed in a modular fashion among a number of different computers or processors to implement various aspects of the present application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the present disclosure includes new and novel improvements to existing methods and technologies, which were not previously known nor implemented to achieve the useful results described above. Users of the present method and system will reap tangible benefits from the functions now made possible on account of the specific modifications described herein causing the effects in the system and its outputs to its users. It is expected that significantly improved operations can be achieved upon implementation of the technology.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A method for digital identity (ID) management, comprising:
in a centralized digital identity service, establishing a first user identity by creating a user domain corresponding to said user, said user domain supporting the publishing of digital content to a publicly accessible location of said user domain;
creating a first key pair for said user, the first key pair comprising a first public key and a corresponding first private key, wherein said first key pair is usable for cryptographically secure publication of domain data to said publicly accessible location of said user domain;
obtaining a user certificate from a certificate authority, said user certificate issued by said certificate authority against said first key pair and said user domain;
creating a second key pair for said user, the second key pair comprising a second public key and a corresponding second private key, wherein said second key pair corresponds to a second user ID and is usable for publishing data blocks onto a publicly accessible decentralized data block record base;
publishing a first data block to said decentralized data block record base, the first data block signed using said first private key, the first data block comprising data confirming association of said first public key and said second public key and signed using said first private key;
publishing a second data block to said decentralized data block record base, the second data block signed using said second private key, the second data block comprising data confirming association of said second public key and said first public key and signed using said second private key;
verifiably and publicly linking said first user ID and said second user ID by way of said signed first and second data blocks; and
executing a digital event requiring cryptographic authentication of said user, by providing either of said first user ID or said second user ID to verifiably execute said digital event.

2. The method of claim 1, wherein establishing said first user ID in said centralized digital identity service comprises establishing a domain for said user in a domain name server (DNS).

3. The method of claim 2, wherein said publicly accessible location comprises a Web site.

4. The method of claim 1, wherein creating said user certificate comprises creating a secure socket layer (SSL) certificate corresponding to said user.

5. The method of claim 1, wherein creating said first key pair comprises creating said first public key and said first private key in a public key infrastructure (PKI) compatible with Web2 digital methods.

6. The method of claim 1, wherein creating said second key pair comprises creating said second public key and said second private key in a public key infrastructure (PKI) compatible with Web3 digital methods.

7. The method of claim 1, wherein the first key pair comprises a TLS key pair and said TLS key pair is usable to securely publish said digital content to said user domain.

8. The method of claim 1, wherein said decentralized data block record base comprises an immutable blockchain.

9. The method of claim 1, wherein said digital event comprises a transaction executed through an authentication authority having jurisdiction over a digital subject matter of said transaction.

10. The method of claim 1, further comprising creation of a third key pair for an agent of said user, establishing an authenticated agency relation, and publishing a record of said agency in said decentralized data block record base, so that said agent's third key pair can be used to verifiably execute said digital transaction on behalf of the user.

11. The method of claim 1, further comprising creation of an agent ID corresponding to an agent of said user, wherein the agent ID is verifiably credentialed to permit delegation of said executing of the digital event to the agent on behalf of the user.

12. The method of claim 1, said publishing of the first and second data blocks comprising a verifiable linking of said first and second user IDs.

13. The method of claim 12, said verifiable linking of the first and second user IDs comprising a defined scope, the defined scope limiting the association with respect to one or more of: a time frame and a type of digital event.

14. A system for digital identity (ID) management, comprising:
an identity governance server having:
a plurality of hardware and software internal data management units including one or more of: a digital identity data store and a digital key management vault;
a plurality of hardware and software external interfaces to respective external data processors, the external interfaces including one or more of:
a cloud identity service interface, placing said identity governance server in data communication with a user or user agent through a cloud identity service unit;
a user identity interface, placing said identity governance server in data communication with a centralized digital identity service, and receiving from said centralized identity service a user domain corresponding to a first user ID;
a certificate authority interface, placing said identity governance server in data communication with a certificate authority, and receiving certificates therefrom corresponding to a second user ID;
a block record base interface placing said identity governance server in data communication with a decentralized data block record base, the block record base interface that generates and publishes a first data block confirming association of said first public key and said second public key and signed using said first private key, the block record base interface further generating and publishing a second data block confirming association of said second public key and said first public key and signed using said second private key;
a digital key pair generator that creates a first pair of digital keys corresponding to said domain enabling cryptographic certification, and a second pair of keys enabling publication of data blocks onto said decentralized data block record base; and
a digital signing unit that provides a digital signature and executes a digital event over a data connection with said identity management server, said digital signature enabled to execute said digital event using either said second user ID on behalf of said first user ID or using said first user ID on behalf of said second user ID.

15. A method for linking digital identities, comprising:
generating a first digital identity corresponding to a user, said first digital identity corresponding to a first digital key pair, said first digital key pair comprising a first public key and a first private key;
generating a second digital identity corresponding to said user, said second digital identity corresponding to a second digital key pair, said second digital key pair comprising a second public key and a second private key;
publishing an identity linking message to a publicly accessible immutable ledger, said identity linking message encoding a linking of said first and second digital identities, and the identity linking message further comprising a digital signature using said first private key and a digital signature using said second private key so as to establish a publicly verifiable mutual association between said first and second digital identities; and
executing a digital event across multiple digital platforms, using said identity linking message for decentralized digital identity verification of said user, without reliance on a centralized identity service for executing said digital event.

16. The method of claim 15, wherein said immutable ledger comprises a blockchain.

17. A method for linking digital identities, comprising:
generating a first digital identity corresponding to a user, said first digital identity corresponding to a first digital key pair, said first digital key pair comprising a first public key and a first private key;
generating a second digital identity corresponding to said user, said second digital identity corresponding to a second digital key pair, said second digital key pair comprising a second public key and a second private key;
publishing a first data block to a publicly accessible immutable ledger, said first data block encoding an association of said first and second digital identities, and encoding a first digital signature using said first private key;
publishing a second data block to said publicly accessible immutable ledger, said second data block encoding an association of said second and first digital identities, and encoding a second digital signature using said second private key; and
executing a digital event using said first and second data blocks for decentralized digital identity verification of said user, without reliance on a centralized identity service for executing said digital event.

18. The method of claim 17, wherein said immutable ledger comprises a blockchain.

19. The method of claim 18, said first and second data blocks comprising respective first and second time stamps corresponding to said first and second data blocks, respectively.

20. The method of claim 18, said first and second data blocks comprising an encoded scope of association between said first and second digital identities.

21. A method for digital key management in a digital identity management system, comprising:
receiving a signal indicating a compromise or loss of a digital key in a first digital key pair comprising a first public key and a first private key;
using a domain name service (DNS) governance method to verify a digital domain ownership wherein said domain is linked to said first digital key pair;
publishing an unlinking message to a publicly accessible immutable ledger to revoke an authorization of said lost cryptographic key;
generating a second digital key pair comprising a second public key and a second private key; and
linking said second key pair to said domain;
publishing a linking message to said publicly accessible immutable ledger, allowing for digital key recovery without reliance on a centralized authority for said digital key recovery.
